(19) United States
(12) Patent Application Publication
(10) Pub. No.: US 2019/0204914 A1
(43) Pub. Date: Jul. 4, 2019

(54) LINE OF SIGHT MEASUREMENT DEVICE

(71) Applicant: DENSO CORPORATION, Kariya-city (JP)

(72) Inventor: Yoshiyuki TSUDA, Kariya-city (JP)

(21) Appl. No.: 16/296,371

(22) Filed: Mar. 8, 2019

Related U.S. Application Data
(63) Continuation of application No. PCT/JP2017/028666, filed on Aug. 8, 2017.

(30) Foreign Application Priority Data
Sep. 13, 2016 (JP) 2016-178769

(51) Int. Cl. G06F 3/01; H04N 5/235; H04N 5/232; H04N 5/225

(52) U.S. Cl. CPC G06F 3/013; H04N 5/2256; H04N 5/23229; H04N 5/2353

(57) ABSTRACT

A line of sight measurement device includes an imaging unit and a line of sight measurement unit. The imaging unit includes a variable exposure level and is configured to capture an image of a subject. The line of sight measurement unit measures a line of sight direction of the subject based on the image captured by the imaging unit. The imaging unit is configured to continuously alternate between capturing a first image showing an entire face of the subject at a first exposure level, and capturing a second image showing an area around the eyes of the subject at a second exposure level set higher than the first exposure level. The line of sight measurement unit is configured to correct a positional deviation between the first image and the second image.

### CROSS-REFERENCE TO RELATED APPLICATIONS

The present application is a continuation application of International Patent Application No. PCT/JP2017/028666 filed on Aug. 8, 2017, which designated the United States and claims the benefit of priority from Japanese Patent Application No. 2016-178769 filed on Sep. 13, 2016. The entire disclosures of all of the above applications are incorporated herein by reference.

### TECHNICAL FIELD

The present disclosure relates to a line of sight measurement device.

### BACKGROUND

A line of sight measurement device may be provided for a vehicle to measure the line of sight of the driver of the vehicle. In this case, it may be desirable to improve the accuracy of the line of sight detection.

### SUMMARY

A line of sight measurement device according to the present disclosure may include an imaging unit and a line of sight measurement unit. The imaging unit includes a variable exposure level and is configured to capture an image of a subject. The line of sight measurement unit measures a line of sight direction of the subject based on the image captured by the imaging unit. The imaging unit is configured to continuously alternate between capturing a first image showing an entire face of the subject at a first exposure level, and capturing a second image showing an area around the eyes of the subject at a second exposure level set higher than the first exposure level. The line of sight measurement unit is configured to correct a positional deviation between the first image and the second image.

### BRIEF DESCRIPTION OF DRAWINGS

These and other objects, features and advantages of the present disclosure will become more apparent from the following detailed description when taken in conjunction with the accompanying drawings.

FIG. 1 is a configuration diagram showing an overall configuration of a line of sight measurement device.

FIG. 2A is a flowchart showing the content of control in an exposure control.

FIG. 2B is a diagram showing an imaging range of a face image.

FIG. 3A is an illustrative view showing an exposure evaluation in a first image.

FIG. 3B is an illustrative view showing an exposure evaluation in a second image.

FIG. 4A is a flowchart showing a basic control content in a line of sight measurement control.

FIG. 4B is an illustrative view related to the flowchart of FIG. 4A.

FIG. 5A is a diagram showing that a position of a driver' face is deviated between the first image and the second image.

FIG. 5B is a diagram showing that a deviation of FIG. 5A is corrected.

FIG. 6 is a flowchart showing the content of a line of sight measurement control according to a first embodiment.

FIG. 7 is an illustrative view showing an outline for extracting a feature portion when detecting a movement.

FIG. 8 is a flowchart showing the content of a line of sight measurement control according to a second embodiment.

FIG. 9 is a flowchart showing the content of a light and dark switching control according to a third embodiment.

FIG. 10 is a flowchart showing the content of a light and dark switching control according to a fourth embodiment.

### DESCRIPTION OF EMBODIMENTS

Hereinafter, a plurality of modes for carrying out the present disclosure will be described with reference to the drawings. In each of the embodiments, the same reference numerals are assigned to portions corresponding to the items described in the preceding embodiments, and a repetitive description of the same portions may be omitted. When only a part of the configuration is described in each form, the other forms described above can be applied to the other parts of the configuration. Not only portions which are specifically clarified so as to be combined in each embodiment are capable of being combined, but also embodiments are capable of being partially combined with each other even though combination is not clarified as long as no adverse effect is particularly generated with respect to the combination.

### First Embodiment

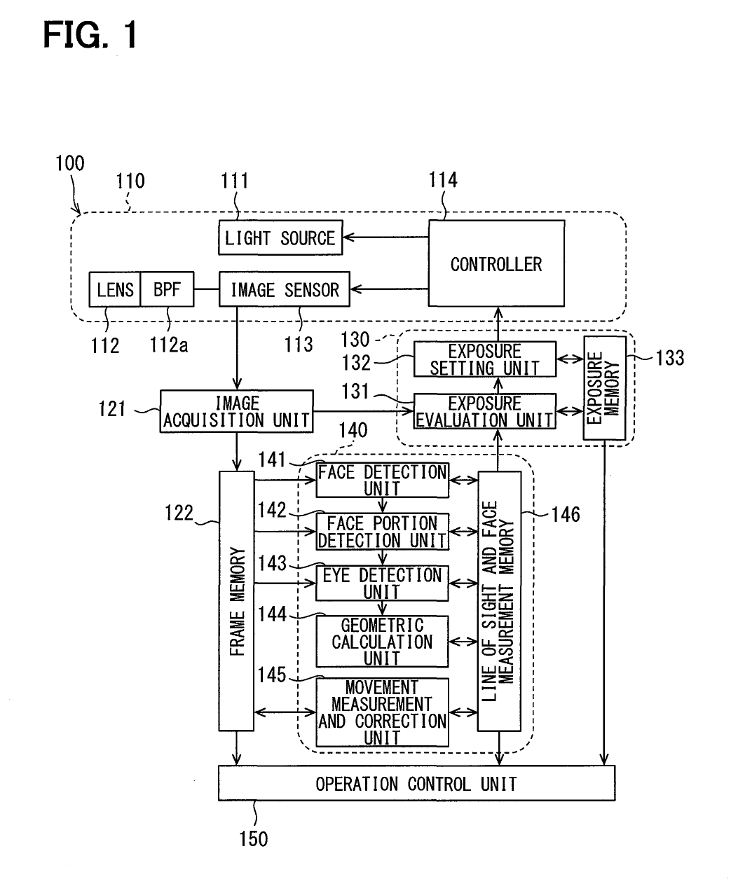

A line of sight measurement device 100 according to a first embodiment will be described with reference to FIGS. 1 to 7. The line of sight measurement device 100 is, for example, a device mounted on a vehicle for capturing an image of a face (face image) of a driver (subject) to measure a line of sight direction based on the captured face image. For example, various devices such as a vehicle navigation apparatus, a vehicle audio device, and/or a vehicle air conditioning device are mounted on the vehicle. When the line of sight direction (line of sight destination) measured by the line of sight measurement device 100 coincides with a position of any of various switch units of various devices, that switch unit is turned on.

In the line of sight measurement device 100, the opening degree of eyes can also be measured according to the face image. For example, it is determined whether or not the driver is drowsy from the opening degree of the eyes, and when it is determined that the driver is drowsy, an alarm or the like can be activated to wake the driver. Alternatively, safety driving support such as decelerating by operating a brake device or forcibly stopping can be performed.

As shown in FIG. 1, the line of sight measurement device 100 includes an imaging unit 110, an image acquisition unit 121, a frame memory 122, an exposure control unit 130, a line of sight measurement unit 140, an operation control unit 150, and the like.

The imaging unit 110 captures a face image of the driver with a variable exposure level. The imaging unit 110 is mounted on, for example, an upper portion of a steering column, a combination meter, an upper portion of a front windshield, or the like so as to face the face of the driver. The imaging unit 110 includes a light source 111, a lens 112, a bandpass filter 112a, an image sensor 113, a controller 114, and the like.

The light source 111 emits a light such as near infrared rays toward the face of the driver in order to capture a face image. In the light source 111, for example, an exposure time, a light source intensity, and the like are controlled by the controller 114. As a result, the exposure level at the time of imaging is adjusted.

The lens 112 is provided on the driver side of the image sensor 113, and focuses the light emitted from the light source and reflected by the face of the driver toward the image sensor 113.

The bandpass filter (BPF) 112a is an optical filter having a characteristic of passing only a light having a specific wavelength in order to reduce an influence of disturbance such as sun or external illumination. In the present embodiment, the bandpass filter 112a passes only a near-infrared wavelength from the light source 111. The bandpass filter 112a is disposed on a front surface of the lens 112 or between the lens 112 and the image sensor 113.

The image sensor 113 is an image pickup device that converts an image formed by the lens 112 into an electric signal and captures (acquires) the face image of the driver, and, for example, a gain or the like of the image sensor 113 is controlled by the controller 114. As a result, the exposure level at the time of imaging is adjusted. When capturing the face image, the image sensor 113 continuously acquires 30 frames of captured data per second, for example.

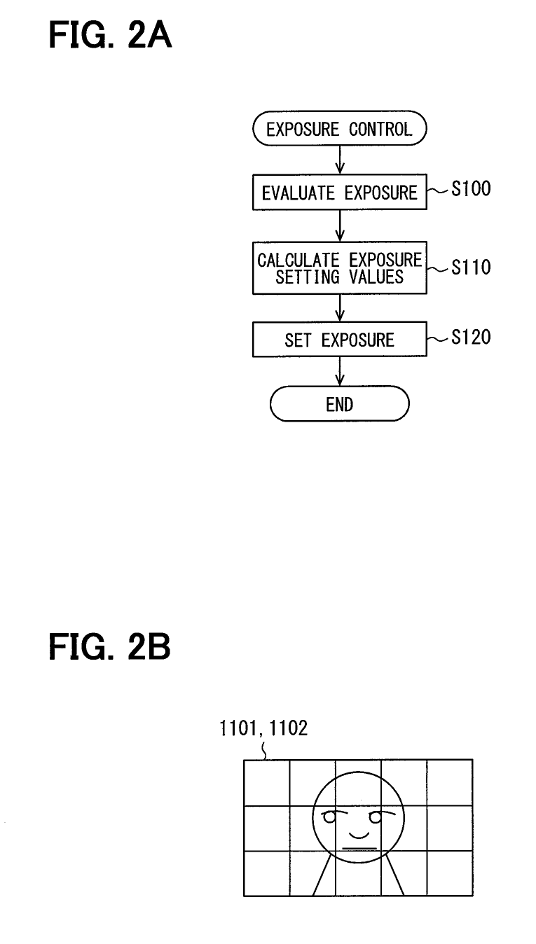

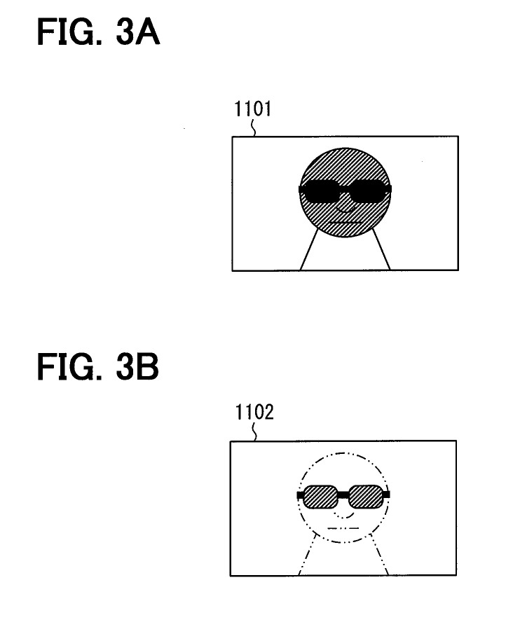

As will be described later, the image sensor 113 captures the face image in an area shown in FIG. 2B, for example, while continuously alternating between a first exposure level condition and a second exposure level condition. The face image at the first exposure level is mainly a first image 1101 (FIG. 3A) showing the entire face except the area around the eyes of the driver. The face image at the second exposure level is primarily a second image 1102 (FIG. 3B) that shows the area around the eyes of the driver. In the case of capturing 30 frames per second, for example, the first image 1101 is an image for 15 odd-numbered frames out of 30 frames, and the second image 1102 is an image for 15 even-numbered frames. In this manner, the image sensor 113 alternately and continuously captures the first image 1101 and the second image 1102, and outputs data of the captured face image to the image acquisition unit 121.

The controller 114 controls the light source 111 and the image sensor 113 based on an instruction from the exposure control unit 130 so as to attain an exposure level required for capturing the face image. In capturing the face image, the controller 114 controls the light source 111 and the image sensor 113 so as to be at the first exposure level when capturing the first image 1101 and to be at the second exposure level when capturing the second image 1102.

Generally, in imaging the area around the eyes, it is difficult to accurately image eyelids, pupils (or irises) or the like because the area around the eyes becomes dark when the face is sharply sculpted around the eyes or when sunglasses are worn by some people. Therefore, the second exposure level is set to a higher value than the first exposure level. Therefore, the first image 1101 is imaged at an exposure level (first exposure level) that is relatively dark, and the second image 1102 is imaged at an exposure level (second exposure level) that is relatively bright.

The image acquisition unit 121 acquires data of the face image output from the image sensor 113. The image acquisition unit 121 outputs the acquired face image data to the frame memory 122 and the exposure control unit 130 (for example, an exposure evaluation unit 131).

The frame memory 122 stores the data of the face image output from the image acquisition unit 121, and further outputs the data to the respective portions of the line of sight measurement unit 140 and the operation control unit 150. In the present embodiment, the respective portions of the line of sight measurement unit 140 include a face detection unit 141, a face portion detection unit 142, an eye detection unit 143, and a correction unit 145.

The exposure control unit 130 controls an exposure level at the time of capturing the face image. The exposure control unit 130 includes an exposure evaluation unit 131, an exposure setting unit 132, an exposure memory 133, and the like.

When capturing the face image, the exposure evaluation unit 131 evaluates an actual exposure level relative to a target exposure level with the use of the luminance of the image. The exposure evaluation unit 131 outputs the data of the evaluated actual exposure level to the exposure memory 133.

The exposure setting unit 132 instructs the controller 114 to bring the actual exposure level at the time of capturing the face image closer to the target exposure level. The exposure setting unit 132 outputs the data of the set exposure level condition to the exposure memory 133.

The exposure memory 133 stores various data involved in the exposure evaluation described above, various data involved in the exposure setting, and the like. In the exposure memory 133, various types of combination data such as an exposure time, a light source intensity, and a gain are provided in advance as a table as various types of data involved in the exposure setting.

The line of sight measurement unit 140 measures the line of sight direction of the driver based on the face image captured by the imaging unit 110, in other words, the face image data output from the frame memory 122. The line of sight measurement unit 140 includes a face detection unit 141, a face portion detection unit 142, an eye detection unit 143, a geometric calculation unit 144, a movement measurement and correction unit 145, a line of sight and face measurement memory 146, and the like.

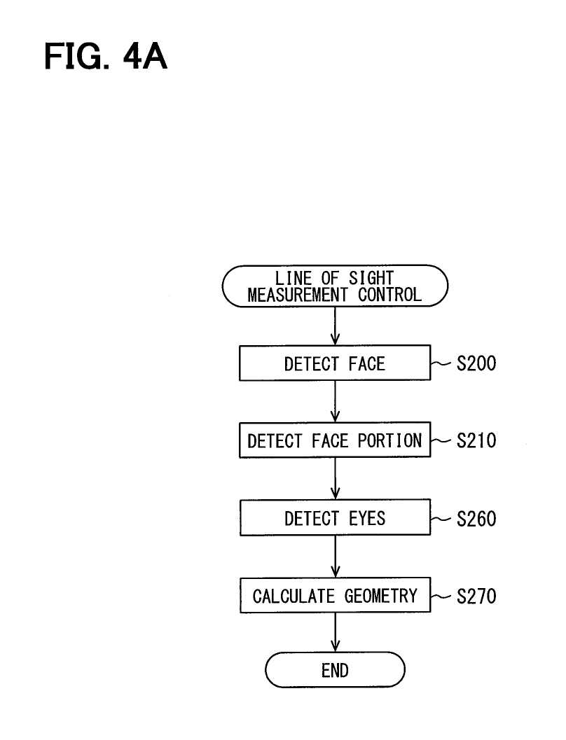

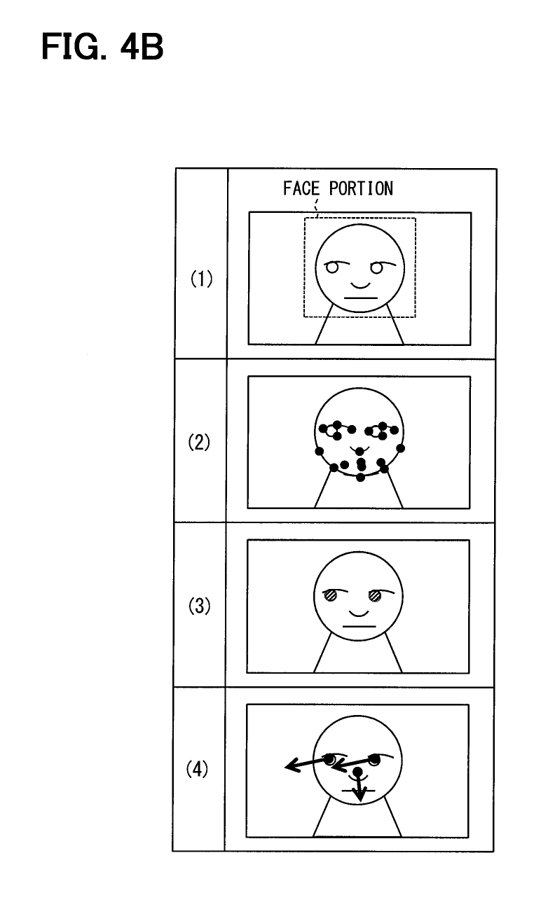

The face detection unit 141 detects a face portion relative to a background as shown in FIG. 4B(1) with respect to the face image (mainly the first image 1101). The face detection unit 141 outputs the detected data to the line of sight and face measurement memory 146.

The face portion detection unit 142 detects a face portion such as the outline of eyes, a nose, a mouth, and a jaw shown in FIG. 4B(2) with respect to the face image (mainly the first image 1101). The face portion detection unit 142 outputs the detected data to the line of sight and face measurement memory 146.

In the face image (mainly the second image 1102), the eye detection unit 143 detects the eyelids, pupils (irises), and the like in the eyes, as shown in FIG. 4B(3). The eye detection unit 143 outputs the detected data to the line of sight and face measurement memory 146.

The geometric calculation unit 144 calculates the face direction and the line of sight direction shown in FIG. 4B(4) in the face image. The geometric calculation unit 144 outputs the calculated data to the line of sight and face measurement memory 146.

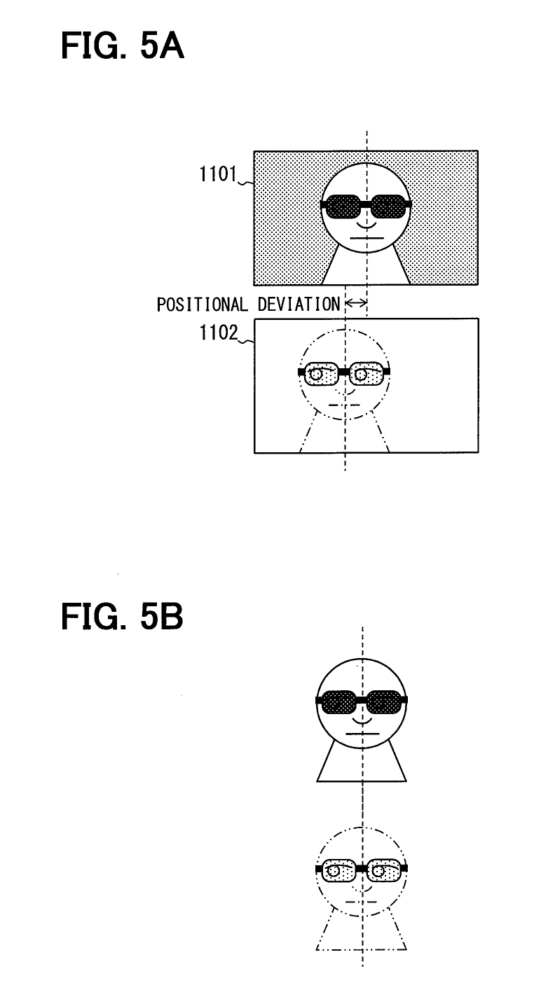

The movement measurement and correction unit 145 measures the movement (amount of movement) of the driver from the first image 1101 and the second image 1102 (FIG. 5A), determines the positional deviation attributable to the movement of the driver, and corrects the positional deviation (FIG. 5B). The movement measurement and correction unit 145 outputs the corrected data to the line of sight and face measurement memory 146.

The line of sight and face measurement memory 146 stores various data obtained by the face detection unit 141, the face portion detection unit 142, the eye detection unit 143, the geometric calculation unit 144, and the movement measurement and correction unit 145, and outputs various data (thresholds, feature amount, and so on) stored in advance to the respective units 141 to 145 and further to the exposure control unit 130 (exposure evaluation unit 131) each time detection or calculation is performed.

The operation control unit 150 notifies the exposure control unit 130, the line of sight measurement unit 140, and the like whether the currently captured face image is the first image 1101 or the second image 1102, based on the data from the frame memory 122 and the line of sight and face measurement memory 146. In addition, the operation control unit 150 determines the frequency of imaging the first image 1101 and the second image 1102 (third embodiment), or determines whether to switch the imaging using the first exposure level and the second exposure level (fourth embodiment). The operation control unit 150 corresponds to a frequency control unit and a switching control unit according to the present disclosure.

The operation of the line of sight measurement device 100 configured as described above will be described below with reference to FIGS. 2 to 7. In the line of sight measurement device 100, the exposure control shown in FIGS. 2A, 3A, and 3B and the line of sight measurement control shown in FIGS. 4 to 7 are executed in parallel. Details of an exposure control, a basic line of sight measurement control, and a sight measurement control according to the present embodiment will be described below.

### 1. Exposure Control

The exposure control is performed by the exposure control unit 130. As shown in FIG. 2A, in Step S100, the exposure control unit 130 first performs an exposure evaluation. The exposure control unit 130 calculates the luminance of the captured first image 1101 and the captured second image 1102 to evaluate each of the first exposure level and the second exposure level. In calculating the luminance, an average luminance or a weighted average luminance in each of the images 1101 and 1102 can be used.

When the weighted average luminance is used, the exposure control unit 130 calculates the luminance with an emphasis on the entire face except for the area around the eyes with respect to the first image 1101 as shown in FIG. 3A, and calculates the luminance with an emphasis on the area around the eyes with respect to the second image 1102 as shown in FIG. 3B.

Next, in S110, the exposure control unit 130 calculates an exposure setting value. The exposure control unit 130 calls a target luminance corresponding to the target exposure level in each of the images 1101 and 1102 from the exposure memory 133, and calculates set values of the exposure time in the light source 111, the light source intensity, the gain in the image sensor 113, and the like so that the actual luminance obtained in S100 approaches the target luminance. The data in the table stored in advance in the exposure memory 133 is used as the combination condition of the exposure time, the light source intensity, and the gain.

In S120, the exposure control unit 130 performs exposure setting. The exposure control unit 130 outputs the set values calculated in S110 to the controller 114. As a result, the first exposure level at the time of capturing the first image 1101 and the second exposure level at the time of capturing the second image 1102 are set. The exposure control is repeatedly executed as the first image 1101 and the second image 1102 are alternately and continuously captured.

### 2. Basic Line of Sight Measurement Control

The line of sight measurement control is executed by the line of sight measurement unit 140. First, a basic line of sight measurement control will be described. As shown in FIG. 4A, in S200, the line of sight measurement unit 140 first performs a face detection. The line of sight measurement unit 140 (face detection unit 141) extracts the feature amount such as shading from the partial image obtained by cutting out a portion of the face image, and determining whether or not the feature is a face with the use of a learned threshold stored in advance in the line of sight and face measurement memory 146, to thereby detects a face portion (FIG. 4B (1)) relative to the background.

Next, in S210, the line of sight measurement unit 140 (the face portion detection unit 142) performs a face portion detection. The line of sight measurement unit 140 sets initial positions of face organ points (outlines of eyes, nose, mouth, outline of jaw, and the like) according to the face detection result, and deforms the face organ points so that a difference between a feature amount such as a shade and a positional relationship and a learned feature amount stored in the line of sight and face measurement memory 146 is minimized, to thereby detect the face portion (FIG. 4B (2)).

Next, in S260, the line of sight measurement unit 140 (eye detection unit 143) performs an eye detection. The line of sight measurement unit 140 detects eyelids, pupils, and the like (FIG. 4B (3)) according to the position of the eyes in the face obtained by the face detection in S200 and the position of the eyes obtained by the face portion detection in S210, with the use of the feature data involved in the eyes (eyelids, pupils, and the like) stored in advance in the line of sight and face measurement memory 146.

Next, in S270, the line of sight measurement unit 140 (geometric calculation unit 144) performs a geometric calculation. The line of sight measurement unit 140 calculates the face direction and the line of sight direction (FIG. 4B (4)) according to the face obtained by the face detection unit 141, the positional relationship of the face portions obtained by the face portion detection unit 142, and the positional relationship of the eyelids, pupils, and the like obtained by the eye detection unit 143.

### 3. Line of Sight Measurement Control

In the line of sight measurement control described above, when the driver moves, a deviation occurs in the position of the face and the position of the eyes between the first image 1101 and the second image 1102. This makes it difficult to accurately determine the position of the eyes and the line of sight direction relative to the face, to thereby decrease an accuracy of line of sight measurement. Therefore, according to the present embodiment, as shown in FIG. 5A, the positional deviation associated with the movement of the driver is determined based on the feature portions (for example, the positions of the eyes) in each of an arbitrary image and a next image captured immediately after the arbitrary image among the first image 1101 and the second image 1102, which are captured alternately and continuously. Then, the positional deviation in the next image with respect to the arbitrary image is corrected, and the line of sight direction of the driver is measured according to the direction of the eyes relative to the face.

As described above, the first image 1101 and the second image 1102 are continuously captured alternately over time. Hereinafter, among the multiple images continuously captured, an arbitrary image is referred to as a first measurement image, the first measurement image being a face image captured first, and a face image captured n-th from the first measurement image is referred to as an n-th measurement image. In other words, when the first measurement image corresponds to the first image 1101, the odd-numbered images among the multiple measurement images are the first images 1101, and the even-numbered images among the multiple measurement images are the second images 1102.

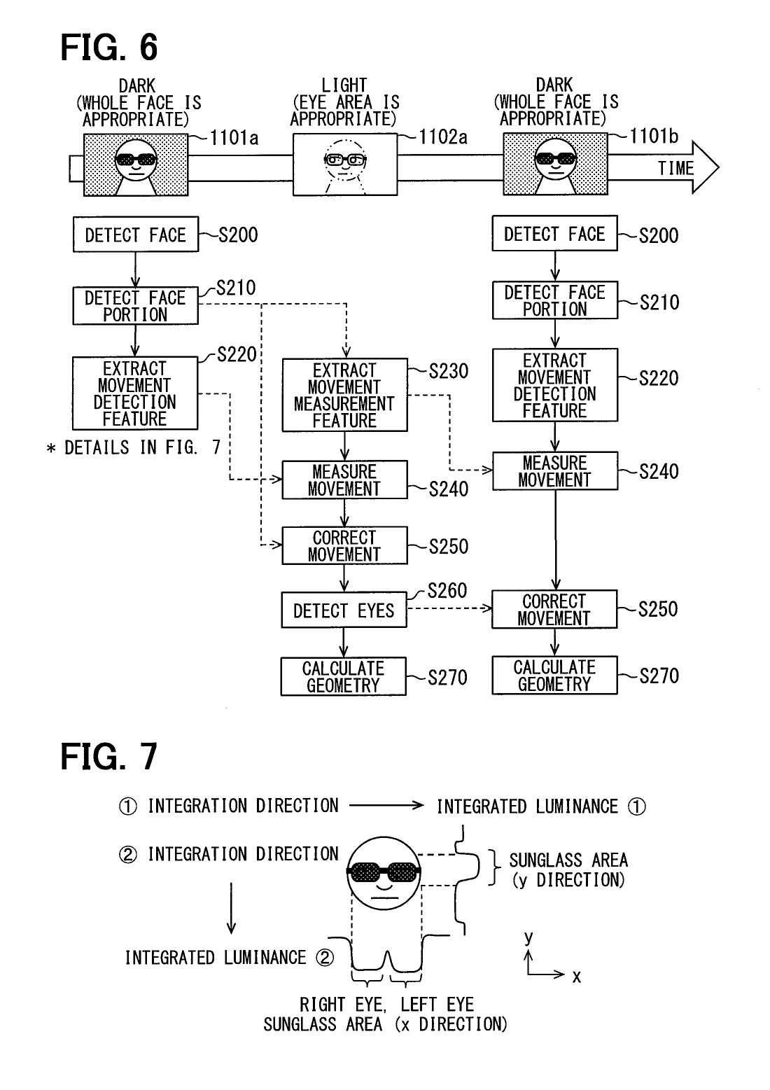

The line of sight measurement control according to the present embodiment will be described with reference to FIG. 6. In a flowchart shown in FIGS. 6, S220, S230, S240, and S250 are added to the flowchart shown in FIG. 4A. The line of sight measurement unit 140 performs the processes of S200, S210, and S220 on the first measurement image 1101a. The line of sight measurement unit 140 performs the processes of S230, S240, S250, S260, and S270 on the second measurement image 1102a. Further, the line of sight measurement unit 140 performs S200, S210, S220, S240, S250, and S270 on a third measurement image 1101b. The line of sight measurement unit 140 sequentially measures the line of sight direction by repeating the above processing.

The line of sight measurement unit 140 performs the face detection (S200) and the face portion detection (S210) described above on the measurement images corresponding to the first images 1101 among the multiple images.

In S220, the line of sight measurement unit 140 extracts the feature portion for movement detection in the measurement image corresponding to the first image 1101. The movement detection feature portion may use, for example, the positions of the eyes (eye positions). The detection of the eye positions can be performed based on the luminance distribution in the face image, for example, as shown in FIG. 7. In the calculation of the luminance distribution, the positions of the eyes can be calculated according to the distribution of the integrated values obtained by integrating the luminance in two directions (x-direction and y-direction) on the face image. For example, when the face is sharply sculpted or when sunglasses are worn, the luminance around the eyes tends to be low. Therefore, an area in which the integrated luminance calculated as described above is relatively low can be extracted as the positions of the eyes.

In S220, the positions of the eyes can be detected with the use of a luminance histogram. The luminance histogram indicates an occurrence frequency of the luminance in the face image, and for example, a portion of an area having the luminance lower than a predetermined luminance can be extracted as the positions of the eyes by a discriminant analysis method.

In S230 to S270, the line of sight measurement unit 140 detects the eyes in the measurement image corresponding to the second image 1102, and calculates the line of sight direction in consideration of the movement of the driver.

In other words, in an example shown in FIG. 6, in S230, the line of sight measurement unit 140 extracts the feature portion for movement detection (for example, the positions of the eyes) in the second measurement image 1102a corresponding to the second image 1102, as in S220.

As the movement detection feature portion, the “image itself” can be used as described below, instead of the case in which the “eye positions” are used as described above. In other words, the second image 1102 is processed by masking an area in which overexposure occurs (mainly an area other than the area around the eyes) in the second image 1102, and matching the second exposure level in the second image 1102 with the first exposure level of the first image 1101. The movement detection can be performed by searching for a position where a total of differences between the first images 1101 and the second images 1102 is minimized, with the use of the second images 1102 itself, having been corrected so that the brightness of the second image 1102 becomes approximately the same as that of the first image 1101, as the feature portion.

Next, in S240, the line of sight measurement unit 140 performs a movement measurement. The line of sight measurement unit 140 measures the amount of positional deviation associated with the movement of the driver according to the positions of the eyes extracted based on the first measurement image 1101a in S220 and the positions of the eyes extracted based on the second measurement image 1102a in S230.

Next, in S250, the line of sight measurement unit 140 performs a movement correction. The line of sight measurement unit 140 performs the movement correction with the use of the positional deviation amount measured in S240. For example, the position correction is performed on the second measurement image 1102a based on the coordinates of the face portion of the first measurement image 1101a detected in S210.

Next, the line of sight measurement unit 140 detects the eyes such as the eyelids and the pupils in S260, and calculates the face direction and the line of sight direction in S270 in the second measurement image 1102a whose position has been corrected.

The line of sight measurement unit 140 performs a movement detection feature extraction (S220) on the third measurement image 1101b, performs a movement calculation (S240) and a movement correction (S250) in comparison with the second measurement image 1102a, and calculates the line of sight direction (S270). Then, the line of sight measurement unit 140 sequentially measures the line of sight direction by repeating the control described above between an immediately preceding image and a next image. In other words, the line of sight measurement unit 140 measures the line of sight direction by comparing a center measurement image with two measurement images before and after the center measurement image with the use of the three consecutive measurement images.

As described above, according to the present embodiment, the line of sight measurement unit 140 measures the line of sight direction using two consecutive images of the first images 1101 and the second images 1102, which are captured alternately and consecutively. One of the two consecutive images is an arbitrary image, and the other image is an image captured immediately after the arbitrary image (next image). The line of sight measurement unit 140 compares the two images with each other, and determines positional deviation associated with the movement of the driver based on the feature portion for detecting the movement. Subsequently, the positional deviation of the other image relative to one image is corrected to measure the line of sight direction from the direction of the eyes relative to the face. This makes it possible to perform more accurate measurement of the line of sight direction even when the driver moves.

For example, consider a reference example line of sight measurement device that simply captures a first captured image a the second captured image of a driver at extremely short time intervals. In the reference example device, the face of the driver imaged in the second captured image is regarded (assumed) as being imaged substantially at the same position and in the same state as in the first captured image. In other words, for the reference example device, it is assumed that the driver is not moving, and the first captured image and the second captured image are obtained at an extremely short time interval so that it is assumed that the face and eyes of the driver are imaged substantially at the same position and in the same state between those captured images. However, if the face of the driver has moved, even if the first captured image and the second captured image are obtained at the extremely short time interval, the position of the face and the position of the eyes in the two images deviate from one another. This would make it difficult to accurately determine the position of the eyes and the line of sight direction with respect to the face, thereby decreasing an accuracy of the line of sight measurement. In contrast, according to the present disclosure, in an arbitrary image and a next image, the line of sight measurement unit determines a positional deviation based on the feature portion for detecting the movement, corrects the positional deviation, and measures the line of sight direction according to the direction of the eyes with respect to the face. As a result, the line of sight direction can be measured with more precision even when the person to be imaged is moving.

Further, in S220 and S230, the line of sight measurement unit 140 determines the positions of the eyes as the feature portion for detecting the movement from the integrated value of the luminance in the respective two axial directions (x-direction and y-direction) on the first image 1101 and the second image 1102. As a result, the line of sight measurement unit 140 can accurately determine the positions of the eyes.

In S230, as the feature portion for detecting the movement, a processed version of the second image 1102 can be used. Specifically, the second image 1102 is processed so as to mask an area in which overexposure occurs in the second image 1102, and processed to match the second exposure level with the first exposure level. This makes it possible to detect movement.

### Second Embodiment

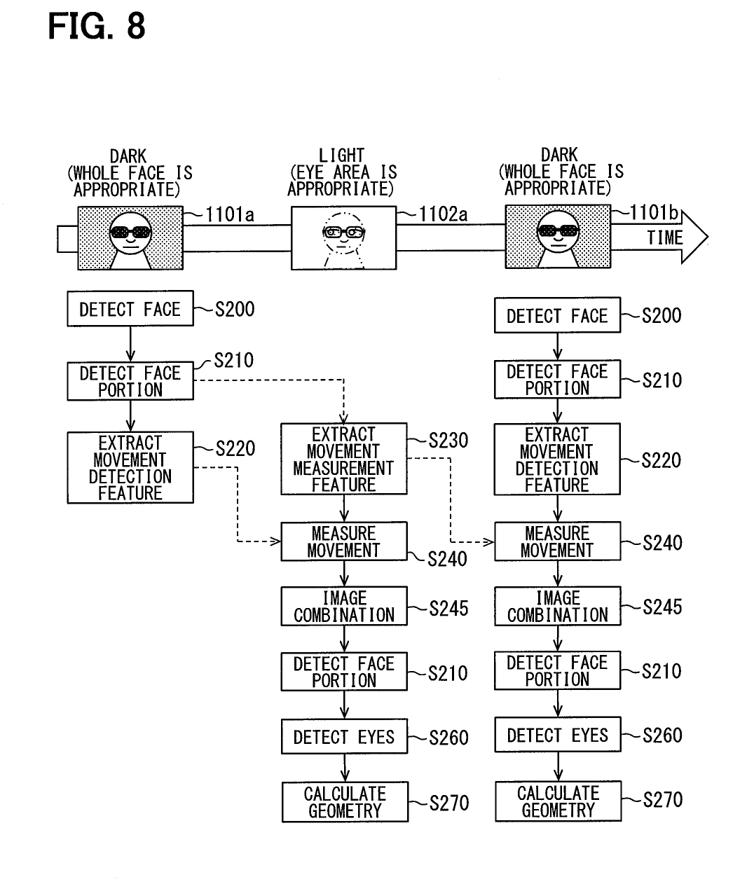

A second embodiment is shown in FIG. 8. The second embodiment has the same configuration as that of the first embodiment, and has the control content different from that of the first embodiment. In a flowchart of FIG. 8, a measurement image corresponding to a first image 1101 and a measurement image corresponding to a second image 1102 are combined together (S245) to measure a line of sight direction.

As shown in FIG. 8, after performing processing in S240, a line of sight measurement unit 140 combines a first measurement image 1101a with a second measurement image 1102a whose positional deviation has been corrected in S245. The line of sight measurement unit 140 performs a face portion detection in S210, an eye detection in S260, and a line of sight direction measurement in S270 on the combined image. Similarly, the second measurement image 1102a and a third measurement image 1101b are subjected to an image combination (S245), and the face portion is detected in S210, the eyes are detected in S260, and the line of sight direction is measured in S270 on the combined image.

As described above, according to the present embodiment, one image of two consecutive images and the other image whose positional deviation is corrected based on the one image are combined together, thereby being capable of accurately measuring the line of sight direction on the combined image.

### Third Embodiment

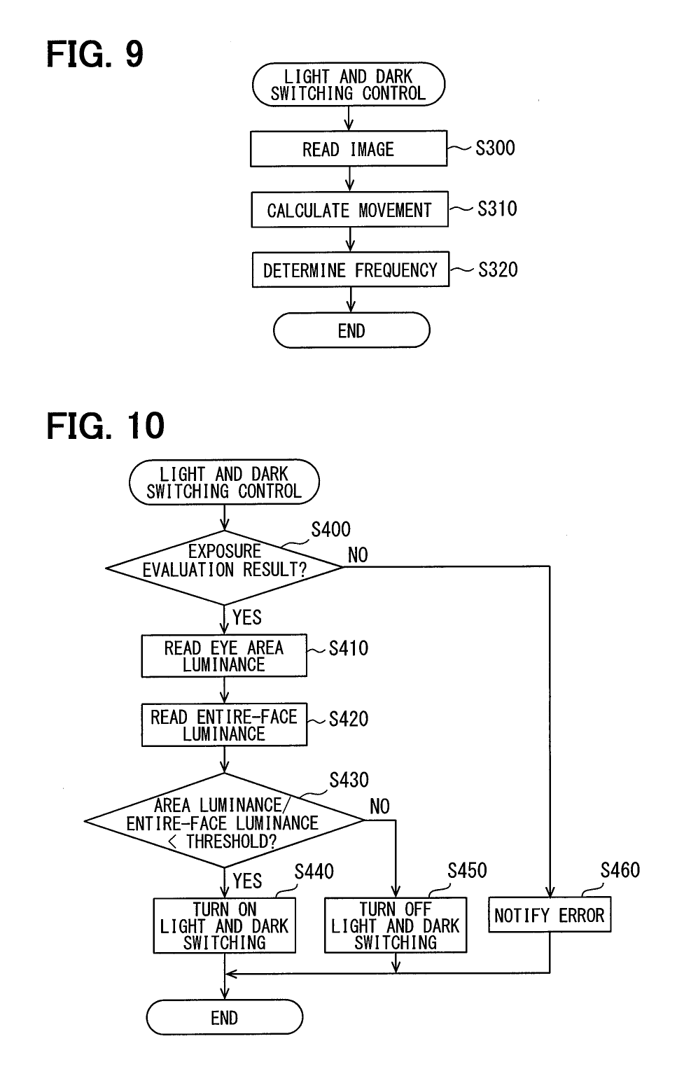

A third embodiment is shown in FIG. 9. The third embodiment has the same configuration as that of the first embodiment. The third embodiment is different from the first embodiment in that an imaging frequency at the time of capturing a first image 1101 is changed with respect to an imaging frequency at the time of capturing a second image 1102 in accordance with the amount of movement of the driver. The change in the imaging frequency is executed by an operation control unit 150 (frequency control unit).

As shown in FIG. 9, first, in S300, the operation control unit 150 reads the first image 1101 and the second image 1102 from a line of sight and face measurement memory 146. Next, in S310, the operation control unit 150 calculates the movement of the driver according to a comparison of a feature portion for detecting the movement of the first image 1101 and the second image 1102.

Then, in S320, the operation control unit 150 determines the frequency. Specifically, when the amount of movement of the driver calculated in S310 is larger than a predetermined amount of movement (for example, for a predetermined time), the operation control unit 150 increases the imaging frequency of the first image 1101 to be greater than the imaging frequency of the second image 1102. The combination of the imaging frequencies of the first image 1101 and the second image 1102 corresponding to the amount of movement is stored in advance in the operation control unit 150.

Specifically, for example, in the first embodiment, the first image 1101 and the second image 1102 have been described as images each using data for 15 frames out of 30 frames/second. On the other hand, in S320, for example, the first image 1101 is changed to an image for 20 frames, and the second image 1102 is changed to an image for 10 frames.

When the amount of movement of the driver is larger than the predetermined amount of movement, the second image 1102 showing the area around the eyes is likely to be relatively inaccurate as compared with the first image 1101 showing the entire face. Therefore, with an increase in the imaging frequency of the first image 1101 showing the entire face, first, the accuracy of the first image 1101 can be increased. The line of sight direction is measured with the use of the second image 1102 (around the eyes) on the basis of the first image 1101 (the entire face) with an increased accuracy, a more accurate line of sight direction can be obtained even when the amount of movement of the driver is large.

### Fourth Embodiment

A fourth embodiment is shown in FIG. 10. The fourth embodiment has the same configuration as that of the first embodiment. The fourth embodiment is different from the first embodiment in that it is determined whether or not to switch between the setting of a first exposure level and the setting of a second exposure level according to a luminance of a second image 1102 relative to a luminance of a first image 1101. The switching of the exposure level is determined by an operation control unit 150 (switching control unit).

As shown in FIG. 10, first, in S400, the operation control unit 150 determines whether or not there is an exposure evaluation result of each of the images 1101 and 1102 in an exposure control described in FIG. 2A for an exposure control unit 130.

If an affirmative determination is made in S400, the operation control unit 150 reads luminance data of the second image 1102 (an image around eyes) in S410, and reads the luminance data of the first image 1101 (an image of the entire face) in S420.

Next, in S430, the operation control unit 150 determines whether or not the luminance of the image around the eyes relative to the luminance of the image of the entire face is smaller than a predetermined threshold.

If an affirmative determination is made in S430, the luminance around the eyes is at a relatively low level, and therefore, in order to capture the second image 1102, there is a need to increase the exposure level as compared with the case of capturing the first image 1101. Therefore, in S440, as in the first embodiment, the operation control unit 150 executes an exposure level switching control (light and dark switching ON) such as setting an exposure level to a first exposure level when capturing the first image 1101 and setting the exposure level to a second exposure level when capturing the second image 1102.

On the other hand, when a negative determination is made in S430, since the luminance around the eyes is at a relatively high level, in order to image the second image 1102, the same exposure level as that at the time of imaging the first image 1101 can be applied. Therefore, when capturing the first image 1101 and capturing the second image 1102 in S450, the operation control unit 150 performs a control (light and dark switching OFF) requiring no switching between the first exposure level and the second exposure level with both of the first image 1101 and the second image 1102 captured at the first exposure level.

On the other hand, if a negative determination is made in S400, the operation control unit 150 determines that the exposure evaluation has not yet been performed, performs an error notification in S460, and completes the flow.

### Other Embodiments

It should be noted that the present disclosure is not limited to the embodiments described above, and can be modified as appropriate within a scope that does not deviate from the spirit of the present disclosure. The above embodiments are not irrelevant to each other, and can be appropriately combined together except when the combination is obviously impossible. In addition, the elements configuring each of the above embodiments are not necessarily essential except when it is clearly indicated that the elements are essential in particular, when the elements are clearly considered to be essential in principle, and the like.

In each of the above embodiments, the numerical values of the components are not limited to a specific number, except when numerical values such as the number, numerical value, quantity, and range of the components are referred to, in particular, when it is clearly indicated that the components are indispensable, and when the numerical value is obviously limited to a specific number in principle, and the like. Further, in each of the above embodiments, the material, shape, positional relationship, and the like of the components and the like are not limited to the above-described specific examples, except for the case where the material, the shape, and the positional relationship are specifically specified, and the case where the material, the shape, and the positional relationship are fundamentally limited to a specific material, shape, positional relationship, and the like.

The operation control unit 150 may perform switching control of the exposure level setting at any of the following timings, for example.

(1) Initial Startup

(2) Predetermined time Interval

(3) When the face detection result is interrupted for a predetermined period of time or longer

(4) After the eye detection error in the light and dark switching OFF state is continued for a predetermined period of time or longer

As a result, when the luminance of the second image 1102 indicating the area around the eyes is larger than the predetermined threshold value, an excellent image around the eyes can be obtained without setting the exposure level to be increased. Therefore, switching between the setting of the first exposure level and the setting of the second exposure level becomes unnecessary. In other words, the first image 1101 and the second image 1102 can be captured while maintaining the first exposure level.

1. A line of sight measurement device, comprising:
an imaging unit having a variable exposure level configured to capture an image of a subject;
a line of sight measurement unit that measures a line of sight direction of the subject based on the image captured by the imaging unit; and
an operation control unit, wherein
the imaging unit is configured to continuously alternate between
capturing a first image showing an entire face of the subject at a first exposure level, and
capturing a second image showing an area around the eyes of the subject at a second exposure level set higher than the first exposure level,
the line of sight measurement unit is configured to
determine a positional deviation associated with a movement of the subject between an arbitrary image and a next image among the first image and the second image which are continuously captured alternately, the positional deviation being determined based on based on a feature portion for detecting movement, and
correct the positional deviation of the next image with respect to the arbitrary image to measure the line of sight direction according to a direction of eyes with respect to face, and
the operation control unit that is configured to, when a luminance of the second image compared to a luminance of the first image is greater than a predetermined threshold value, control the imaging unit to switch from setting the second exposure level to setting the first exposure level when capturing the second image.

2. The line of sight measurement device according to claim 1, wherein
the line of sight measurement unit is configured to combine the arbitrary image with the positional deviation corrected next image to measure the line of sight direction.

3. The line of sight measurement device according to claim 1, wherein
The operation control unit is further configured to control the imaging unit to set an imaging frequency of the first image to be higher than an imaging frequency of the second image when a movement amount of the subject is larger than a predetermined movement amount.

4. The line of sight measurement device according to claim 1, wherein
the line of sight measurement unit is configured to determine the feature portion according to an integrated value of luminance in two axial directions on each of the first image and the second image.

5. The line of sight measurement device according to claim 1, wherein
the line of sight measurement unit is configured to process the second image by masking overexposed areas and matching the second exposure level to the first exposure level, and to use the processed second image as the feature portion.

6. A line of sight measurement device, comprising:
a camera having a variable exposure level configured to capture an image of a subject;
a calculation processor including a first memory and coupled to the camera to receive the image captured by the camera; and
a control processor including a second memory and coupled to the camera and the calculation processor, wherein
the camera is configured to continuously alternate between
capturing a first image showing an entire face of the subject at a
first exposure level, and capturing a second image showing an area around the eyes of the subject at a second exposure level set higher than the first exposure level,
the control processor is configured to execute programming stored in the first memory to:
determine a positional deviation associated with a movement of the subject between an arbitrary image and a next image among the first image and the second image which are continuously captured alternately, the positional deviation being determined based on based on a feature portion for detecting movement, and
correct the positional deviation of the next image with respect to the arbitrary image to measure a line of sight direction according to a direction of the eyes of the subject with respect to the face of the subject, and
the control processor is configured to execute programming stored in the second memory to when a luminance of the second image compared to a luminance of the first image is greater than a predetermined threshold value, control the camera to switch from setting the second exposure level to setting the first exposure level when capturing the second image.
